(19) United States
(12) Patent Application Publication
(10) Pub. No.: US 2005/0008940 A1
(43) Pub. Date: Jan. 13, 2005

(54) Battery

(76) Inventors: Momoe Adachi, Tokyo (JP); Hiroyuki Akashi, Kanagawa (JP); Shigeru Fujita, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/494,090

(22) PCT Filed: Nov. 8, 2002
(86) PCT No.: PCT/JP02/11668

(30) Foreign Application Priority Data
Nov. 9, 2001 (JP) 2001-345222

(51) Int. Cl. H01M 10/40; H01M 4/58; H01M 4/42; H01M 4/38

(52) U.S. Cl. 429/327; 429/329; 429/330; 429/231.8; 429/218.1; 429/229; 429/226; 429/336; 429/337; 429/338

(57) ABSTRACT

Provided is a battery capable of improving chemical stability of an electrolyte and battery characteristics such as discharge capacity, charge-discharge cycle characteristics and so on. The battery comprises a spirally wound electrode body (20) including a strip-shaped cathode (21) and a strip-shaped anode (22) spirally wound with a separator (23) in between. During charge, lithium metal is precipitated on the anode (22), so the capacity of the anode (22) includes a capacity component by insertion and extraction of lithium and a capacity component by precipitation and dissolution of the lithium metal, and is represented by the sum of them. The separator (23) is impregnated with an electrolyte solution formed through dissolving a lithium salt in a solvent. Vinyl ethylene carbonate, divinyl ethylene carbonate or the like is added to the electrolyte solution, thereby the chemical stability can be improved.

### TECHNICAL FIELD

The present invention relates to a battery comprising a cathode, an anode, and an electrolyte, and more specifically a battery in which the capacity of the anode includes a capacity component by insertion and extraction of light metal and a capacity component by precipitation and dissolution of the light metal, and is represented by the sum of them.

### BACKGROUND ART

In recent years, reduction in size and weight of portable electric devices typified by cellular phones, PDAs (personal digital assistants) or laptop computers has been vigorously pursued, and as part of the reduction, an improvement in energy density of batteries, specifically secondary batteries as power sources for the devices has been strongly required.

As secondary batteries which can obtain a high energy density, for example, a lithium-ion secondary battery using a material capable of inserting and extracting lithium (Li) such as a carbon material or the like for the anode is cited. The lithium-ion secondary battery is designed so that lithium inserted into an anode material is always in an ion state, so the energy density is highly dependent on the number of lithium ions capable of being inserted into the anode material. Therefore, in the lithium-ion secondary battery, it is expected that when the amount of insertion of lithium is increased, the energy density can be further improved. However, the amount of insertion of graphite, which is considered at present to be a material capable of the most effectively inserting and extracting lithium ions is theoretically limited to 372 mAh per gram on an electricity amount basis, and recently the amount of insertion of graphite has been approaching the limit by active development.

Further, as the secondary battery capable of obtaining a high energy density, a lithium secondary battery using lithium metal for an anode, and using only precipitation and dissolution reactions of lithium metal for an anode reaction is also cited. In the lithium secondary battery, a theoretical electrochemical equivalent of the lithium metal is as large as 2054 mAh/cm³, which is 2.5 times larger than that of graphite used in the lithium-ion secondary battery, so it is expected that the lithium secondary battery can obtain a much higher energy density than the lithium-ion secondary battery. A large number of researchers have been conducting research and development aimed at putting the lithium secondary battery to practical use (for example, Lithium Batteries edited by Jean-Paul Gabano, Academic Press, 1983, London, N.Y.).

However, the lithium secondary battery has a problem that when a charge-discharge cycle is repeated, a large decline in its discharge capacity occurs, so it is difficult to put the lithium secondary battery to practical use. The decline in the capacity occurs because the lithium secondary battery uses a precipitation-dissolution reaction of the lithium metal in the anode. In accordance with charge and discharge, the volume of the anode largely increases or decreases by the amount of the capacity corresponding to lithium ions transferred between the cathode and the anode, so the volume of the anode is largely changed, thereby it is difficult for a dissolution reaction and a recrystallization reaction of a lithium metal crystal to reversibly proceed. Further, the higher energy density the lithium secondary battery achieves, the more largely the volume of the anode is changed, and the more pronouncedly the capacity declines.

Therefore, the inventors of the invention have developed a novel secondary battery in which the capacity of the anode includes a capacity component by insertion and extraction of lithium and a capacity component by precipitation and dissolution of lithium, and is represented by the sum of them (refer to International Publication No. WO 01/22519). In the secondary battery, a carbon material capable of inserting and extracting lithium is used for the anode, and lithium is precipitated on a surface of the carbon material during charge. The secondary battery holds promise of improving charge-discharge cycle characteristics while achieving a higher energy density.

However, in order to put the secondary battery to practical use, it is required to achieve a further improvement in the characteristics and higher stability. For this purpose, research and development of not only electrode materials but also electrolytes are absolutely necessary. More specifically, when a side reaction between an electrolyte and an electrode occurs, and a side reaction product is deposited on a surface of the electrode, an internal resistance of the battery increases, thereby the charge-discharge cycle characteristics pronouncedly decline. Further, when lithium is consumed at this time, it may result in a decline in capacity. In short, chemical stability of the electrolyte is a very important issue.

In view of the foregoing, it is an object of the invention to provide a battery capable of improving chemical stability of an electrolyte, and battery characteristics such as discharge capacity, charge-discharge cycle characteristics and so on.

### DISCLOSURE OF THE INVENTION

A battery according to the invention comprises a cathode, an anode and an electrolyte, wherein the capacity of the anode includes a capacity component by insertion and extraction of light metal and a capacity component by precipitation and dissolution of the light metal, and is represented by the sum of them, and the electrolyte includes at least one kind selected from the group consisting of a compound shown in Chemical Formula 1 and a compound shown in Chemical Formula 2.

In the battery according to the invention, in an insertion-extraction reaction of the light metal, reduction and decomposition of a solvent can be inhibited, and in a precipitation-dissolution reaction of the light metal, a reaction between precipitated light metal and the solvent can be prevented. Therefore, chemical stability of the electrolyte is higher, so a higher discharge capacity can be obtained, and cycle characteristics or the like can be improved.

### BRIEF DESCRIPTION OF THE DRAWINGS

FIG. 1 is a sectional view of a secondary battery according to an embodiment of the invention; and

FIG. 2 is an enlarged sectional view of a part of a spirally electrode body in the secondary battery shown in FIG. 1.

### BEST MODE FOR CARRYING OUT THE INVENTION

Preferred embodiments of the invention will be described below in more detail below referring to the accompanying drawings.

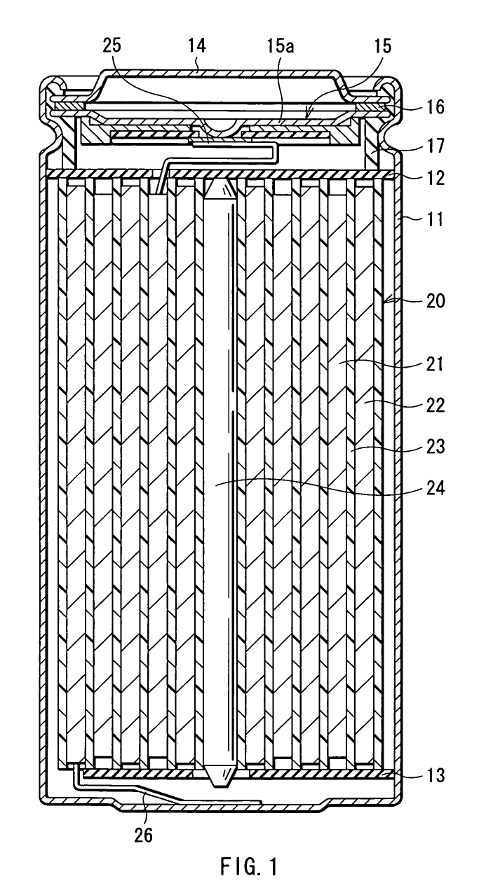

FIG. 1 shows a sectional view of a secondary battery according to an embodiment of the invention. The secondary battery is a so-called cylindrical type, and comprises a spirally wound electrode body 20 including a strip-shaped cathode 21 and a strip-shaped anode 22 spirally wound with a separator 23 in between in a substantially hollow cylindrical-shaped battery can 11. The battery can 11 is made of, for example, nickel (Ni)-plated iron. An end portion of the battery can 11 is closed, and the other end portion thereof is opened. In the battery can 11, a pair of insulating plates 12 and 13 are disposed so that the spirally wound electrode body 20 is sandwiched therebetween in a direction perpendicular to a spirally wound peripheral surface.

In the opened end portion of the battery can 11, a battery cover 14 and, a safety valve mechanism 15 and a positive temperature coefficient device (PTC device) 16 disposed inside the battery cover 14 are mounted through caulking by a gasket 17, and the interior of the battery can 11 is sealed. The battery cover 14 is made of, for example, the same material as that of the battery can 11. The safety valve mechanism 15 is electrically connected to the battery cover 14 through the PTC device 16, and when internal pressure in the battery increases to higher than a certain extent due to an internal short circuit or external application of heat, a disk plate 15a is flipped so as to disconnect the electrical connection between the battery cover 14 and the spirally wound electrode body 20. When a temperature rises, the PTC device 16 limits a current by an increased resistance, thereby resulting in preventing abnormal heat generation by a large current. The PTC device 16 is made of, for example, barium titanate semiconductor ceramic. The gasket 17 is made of, for example, an insulating material, and its surface is coated with asphalt.

The spirally wound electrode body 20 is wound around, for example, a center pin 24. A cathode lead 25 made of aluminum (Al) or the like is connected to the cathode 21 of the spirally wound electrode body 20, and an anode lead 26 made of nickel or the like is connected to the anode 22. The cathode lead 25 is welded to the safety valve mechanism 15 so as to be electrically connected to the battery cover 14, and the anode lead 26 is welded to the battery can 11 so as to be electrically connected to the battery can 11.

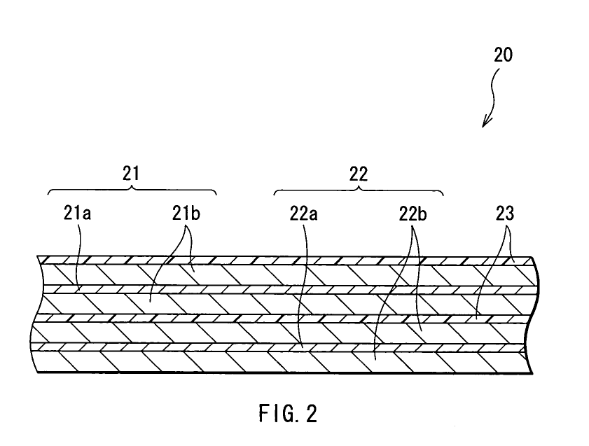

FIG. 2 shows an enlarged view of a part of the spirally wound electrode body 20 shown in FIG. 1. The cathode 21 has, for example, a structure in which a cathode mixed layer 21b is disposed on both sides of a cathode current collector 21a having a pair of surfaces facing each other. In addition, the cathode mixed layer 21b may be disposed on only one side of the cathode current collector 21a, although it is not shown. The cathode current collector 21a is made of, for example, metal foil such as aluminum foil, nickel foil, stainless foil or the like with a thickness of approximately from 5 μm to 50 μm. The cathode mixed layer 21b has, for example, a thickness of 80 μm to 250 μm, and includes a cathode material capable of inserting and extracting lithium which is light metal. Further, when the cathode mixed layer 21b is disposed on both sides of the cathode current collector 21a, the thickness of the cathode mixed layer 21b means the total thickness thereof.

As the cathode material capable of inserting and extracting lithium, for example, a lithium-containing compound such as a lithium oxide, a lithium sulfide, an intercalation compound including lithium or the like is adequate, and a mixture including two or more kinds selected from them may be used. More specifically, in order to achieve a higher energy density, a lithium complex oxide or an intercalation compound including lithium represented by a general formula LiₓMO₂ is preferable. In the formula, as M, one or more kinds of transition metals, more specifically at least one kind selected from the group consisting of cobalt (Co), nickel, manganese (Mn), iron (Fe), aluminum, vanadium (V) and titanium (Ti) is preferable. The value of x depends upon a charge-discharge state of the battery, and is generally within a range of 0.05≦x≦1.10. In addition, LiMn₂O₄ having a spinel crystal structure, LiFePO₄ having an olivine crystal structure, or the like is preferable, because a higher energy density can be obtained.

Further, such a cathode material is prepared through the following steps. For example, after a carbonate, a nitrate, an oxide or a hydroxide including lithium, and a carbonate, a nitrate, an oxide or a hydroxide including a transition metal are mixed so as to have a desired composition, and the mixture is pulverized, the pulverized mixture is fired at a temperature ranging from 600° C. to 1000° C. in an oxygen atmosphere, thereby the cathode material is prepared.

The cathode mixed layer 21b includes, for example, an electronic conductor, and may further include a binder, if necessary. As the electronic conductor, for example, a carbon material such as graphite, carbon black, ketjen black or the like is cited, and one kind or a mixture of two or more kinds selected from them is used. In addition to the carbon material, any electrically conductive material such as a metal material, a conductive high molecular weight material or the like may be used. As the binder, for example, synthetic rubber such as styrene butadiene rubber, fluorine rubber, ethylene propylene diene rubber or the like, or a high molecular weight material such as polyvinylidene fluoride or the like is cited, and one kind or a mixture including two or more kinds selected from them is used. For example, as shown in FIG. 1, when the cathode 21 and the anode 22 are spirally wound, the styrene butadiene rubber, the fluorine rubber or the like having high elasticity is preferably used as the binder.

The anode 22 has, for example, a structure in which an anode mixed layer 22b is disposed on both sides of an anode current collector 22a having a pair of surfaces facing each other. The anode mixed layer 22b may be disposed on only one side of the anode current collector 22a, although it is not shown. The anode current collector 22a is made of, for example, metal foil having excellent electrochemical stability, electric conductivity and mechanical strength such as copper foil, nickel foil, stainless foil or the like. More specifically, the copper foil is the most preferable because the copper foil has high electric conductivity. The anode current collector 22a preferably has a thickness of, for example, approximately 6 μm to 40 μm. When the thickness of the anode current collector 22a is thinner than 6 μm, the mechanical strength declines, so the anode current collector 22a is easily broken during a manufacturing process, thereby production efficiency declines. On the other hand, when it is thicker than 40 μm, a volume ratio of the anode current collector 22a in the battery becomes larger than necessary, so it is difficult to increase the energy density.

The anode mixed layer 22b includes one kind or two or more kinds selected from anode materials capable of inserting and extracting lithium which is light metal, and may further include, for example, the same binder as that included in the cathode mixed layer 21b, if necessary. The anode mixed layer 22b has a thickness of, for example, 80 μm to 250 μm. When the anode mixed layer 22b is disposed on both sides of the anode current collector 22a, the thickness of the anode mixed layer 22b means the total thickness thereof.

In this description, insertion and extraction of light metal mean that light metal ions are electrochemically inserted and extracted without losing their ionicity. It includes not only the case where inserted lithium metal exists in a perfect ion state but also the case where the inserted lithium metal exists in an imperfect ion state. As these cases, for example, insertion by electrochemical intercalation of light metal ions into graphite is cited. Further, insertion of the light metal into an alloy including an intermetallic compound, or insertion of the light metal by forming an alloy can be cited.

As the anode material capable of inserting and extracting lithium, for example, a carbon material such as graphite, non-graphitizable carbon, graphitizing carbon or the like is cited. These carbon materials are preferable, because a change in the crystalline structure which occurs during charge and discharge is extremely small, so a higher charge-discharge capacity and superior charge-discharge cycle characteristics can be obtained. Further, graphite is more preferable, because its electrochemical equivalent is large, and a higher energy density can be obtained.

For example, graphite with a true density of 2.10 g/cm³ or over is preferable, and graphite with a true density of 2.18 g/cm³ or over is more preferable. In order to obtain such a true density, a c-axis crystalline thickness of a (002) plane is required to be 14.0 nm or over. Moreover, the spacing of (002) planes is preferably less than 0.340 nm, and more preferably within a range from 0.335 nm to 0.337 nm.

The graphite may be natural graphite or artificial graphite. The artificial graphite can be obtained through the following steps, for example. An organic material is carbonized, and high-temperature heat treatment is carried out on the carbonized organic material, then the organic material is pulverized and classified so as to obtain the artificial graphite. The high-temperature treatment is carried out in the following steps. For example, the organic material is carbonized at 300° C. to 700° C. in an airflow of an inert gas such as nitrogen (N₂) or the like, if necessary, and then the temperature rises to 900° C. to 1500° C. at a rate of 1° C. to 100° C. per minute, and the temperature is kept for 0 to 30 hours to calcine the organic material, then the organic material is heated to 2000° C. or over, preferably 2500° C. or over, and the temperature is kept for an adequate time.

As the organic material as a starting material, coal or pitch can be used. As the pitch, for example, a material which can be obtained by distillation (vacuum distillation, atmospheric distillation or steam distillation), thermal polycondensation, extraction, and chemical polycondensation of tars which can be obtained by thermally cracking coal tar, ethylene bottom oil, crude oil or the like at high temperature, asphalt or the like, a material produced during destructive distillation of wood, a polyvinyl chloride resin, polyvinyl acetate, polyvinyl butyrate, or a 3,5-dimethylphenol resin is cited. These coals and pitches exist in a liquid state around at 400° C. at the highest during carbonization, and by keeping the coal and pitches at the temperature, aromatic rings are condensed and polycycled, so the aromatic rings are aligned in a stacking arrangement. After that, a solid carbon precursor, that is, semi-coke is formed at approximately 500° C. or over (liquid-phase carbonization process).

Moreover, as the organic material, a condensed polycyclic hydrocarbon compound such as naphthalene, phenanthrene, anthracene, triphenylene, pyrene, perylene, pentaphene, pentacene or the like, a derivative thereof (for example, carboxylic acid of the above compound, carboxylic acid anhydride, carboxylic acid imide), or a mixture thereof can be used. Further, a condensed heterocyclic compound such as acenaphthylene, indole, isoindole, quinoline, isoquinoline, quinoxaline, phthalazine, carbazole, acridine, phenazine, phenanthridine or the like, a derivative thereof, or a mixture thereof can be used.

In addition, pulverization may be carried out before or after carbonization and calcination, or during a rise in temperature before graphitization. In these cases, the material in powder form is heated for graphitization in the end. However, in order to obtain graphite powder with a higher bulk density and a higher fracture strength, it is preferable that after the material is molded, the molded material is heated, then the graphitized molded body is pulverized and classified.

For example, in order to form the graphitized molded body, after coke as a filler and binder pitch as a molding agent or a sintering agent are mixed and molded, a firing step in which the molded body is heated at a low temperature of 1000° C. or less and a step of impregnating the fired body with the molten binder pitch are repeated several times, and then the body is heated at high temperature. The binder pitch with which the fired body is impregnated is carbonized by the above heat treatment process so as to be graphitized. In this case, the filler (coke) and the binder pitch are used as the materials, so they are graphitized as a polycrystal, and sulfur or nitrogen included in the materials is generated as a gas during the heat treatment, thereby minute pores are formed in a path of the gas. Therefore, there are some advantages that insertion and extraction of lithium proceed more easily by the pores, and industrial processing efficiency is higher. Further, as the material of the molded body, a filler having moldability and sinterability may be used. In this case, the binder pitch is not required.

The non-graphitizable carbon having the spacing of the (002) planes of 0.37 nm or over and a true density of less than 1.70 g/cm³, and not showing an exothermic peak at 700° C. or over in a differential thermal analysis (DTA) in air is preferable.

Such non-graphitizable carbon can be obtained, for example, through heating the organic material around at 1200° C., and pulverizing and classifying the material. Heat treatment is carried out through the following steps. After, if necessary, the material is carbonized at 300° C. to 700° C. (solid phase carbonization process), a temperature rises to 900° C. to 1300° C. at a rate of 1° C. to 100° C. per minute, and the temperature is kept for 0 to 30 hours. Pulverization may be carried out before or after carbonization or during a rise in temperature.

As the organic material as a starting material, for example, a polymer or a copolymer of furfuryl alcohol or furfural, or a furan resin which is a copolymer including macromolecules thereof and any other resin can be used. Moreover, a conjugated resin such as a phenolic resin, an acrylic resin, a vinyl halide resin, a polyimide resin, a polyamide imide resin, a polyamide resin, polyacetylene, polyparaphenylene or the like, cellulose or a derivative thereof, coffee beans, bamboos, crustacea including chitosan, kinds of bio-cellulose using bacteria can be used. Further, a compound in which a functional group including oxygen (O) is introduced into petroleum pitch with, for example, a ratio H/C of the number of atoms between hydrogen (H) and carbon (C) of from 0.6 to 0.8 (that is, an oxygen cross-linked compound) can be used.

The percentage of the oxygen content in the compound is preferably 3% or over, and more preferably 5% or over (refer to Japanese Unexamined Patent Application Publication No. Hei 3-252053). The percentage of the oxygen content has an influence upon the crystalline structure of a carbon material, and when the percentage is the above value or over, the physical properties of the non-graphitizable carbon can be improved, thereby the capacity of the anode 22 can be improved. Moreover, the petroleum pitch can be obtained, for example, by distillation (vacuum distillation, atmospheric distillation or steam distillation), thermal polycondensation, extraction, and chemical polycondensation of tars obtained through thermally cracking coal tar, ethylene bottom oil or crude oil at high temperature, asphalt or the like. Further, as a method of forming an oxygen cross-link, for example, a wet method of reacting a solution such as nitric acid, sulfuric acid, hypochlorous acid, a mixture thereof or the like and petroleum pitch, a dry method of reacting an oxidizing gas such as air, oxygen or the like and petroleum pitch, or a method of reacting a solid reagent such as sulfur, ammonium nitrate, ammonium persulfate, ferric chloride or the like and petroleum pitch can be used.

In addition, the organic material as the starting material is not limited to them, and any other organic material which can become non-graphitizable carbon through the solid-phase carbonization by an oxygen cross-linking process or the like may be used.

As the non-graphitizable carbon, in addition to the non-graphitizable carbon formed of the above organic material as a starting material, a compound including phosphorus (P), oxygen and carbon as main components which is disclosed in Japanese Unexamined Patent Application Publication No. Hei 3-137010 is preferable, because the above-described parameters of physical properties are exhibited.

As the anode material capable of inserting and extracting lithium, a metal element or a metalloid element capable of forming an alloy with lithium, or an alloy of the metal element or the metalloid element, or a compound of the metal element or the metalloid element is cited. They are preferable because a higher energy density can be obtained, and it is more preferable to use them with a carbon material, because a higher energy density and superior cycle characteristics can be obtained. In the description, the alloy means not only an alloy including two or more kinds of metal elements but also an alloy including one or more kinds of metal elements and one or more kinds of metalloid elements. As the composition of the alloy, a solid solution, a eutectic (eutectic mixture), an intermetallic compound or the coexistence of two or more kinds selected from them is cited.

As such a metal element or a metalloid element, for example, tin (Sn), lead (Pb), aluminum, indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y) or hafnium (Hf) is cited. As an alloy or a compound thereof, for example, an alloy or a compound represented by a chemical formula MaₛMbₜLiᵤ or a chemical formula MaₚMc_{q}Mdᵣ is cited. In these chemical formulas, Ma represents at least one kind selected from metal elements and metalloid elements which can form an alloy or a compound with lithium, Mb represents at least one kind selected from metal elements and metalloid elements except for lithium and Ma, Mc represents at least one kind selected from nonmetal elements, and Md represents at least one kind selected from metal elements and metalloid elements except for Ma. Further, the values of s, t, u, p, q and r are s>0, t≧0, u≧0, p>0, q>0 and r≧0, respectively.

Among them, a metal element or a metalloid element selected from Group 4B, or an alloy thereof or a compound thereof is preferable, and silicon or tin, or an alloy thereof or a compound thereof is more preferable. They may have a crystalline structure or an amorphous structure.

As specific examples of such an alloy or such a compound, LiAl, AlSb, CuMgSb, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), SnO_{w} (0<w≦2), SnSiO₃, LiSiO, LiSnO and so on are cited.

Moreover, as the anode material capable of inserting and extracting lithium, other metal compounds or high molecular weight materials are cited. As the metal compounds, an oxide such as iron oxide, ruthenium oxide, molybdenum oxide or the like, LiN₃, and so on are cited, and as the high molecular weight materials, polyacetylene, polyaniline, polypyrrole and so on are cited.

Moreover, in the secondary battery, during charge, precipitation of lithium metal on the anode 22 begins at a point where an open circuit voltage (that is, battery voltage) is lower than an overcharge voltage. In other words, in a state where the open circuit voltage is lower than the overcharge voltage, the lithium metal is precipitated on the anode 22, so the capacity of the anode 22 includes a capacity component by insertion and extraction of lithium and a capacity component by precipitation and dissolution of the lithium metal, and is represented by the sum of them. Therefore, in the secondary battery, both of the anode material capable of inserting and extracting lithium and the lithium metal have a function as an anode active material, and the anode material capable of inserting and extracting lithium is a base material when the lithium metal is precipitated.

The overcharge voltage means a open circuit voltage when the battery is overcharged, and indicates, for example, a voltage higher than the open circuit voltage of a battery “fully charged” described in and defined by “Guideline for safety assessment of lithium secondary batteries” (SBA G1101) which is one of guidelines drawn up by Japan Storage Battery industries Incorporated (Battery Association of Japan). In other words, the overcharge voltage indicates a higher voltage than an open circuit voltage after charge by using a charging method used when a nominal capacity of each battery is determined, a standard charging method or a recommended charging method. More specifically, the secondary battery is fully charged, for example, at a open circuit voltage of 4.2 V, and the lithium metal is precipitated on a surface of the anode material capable of inserting and extracting lithium in a part of the range of the open circuit voltage of from 0 V to 4.2 V.

Thereby, in the secondary battery, a higher energy density can be obtained, and cycle characteristics and high-speed charge characteristics can be improved, because of the following reason. The secondary battery is equivalent to a conventional lithium secondary battery using lithium metal or a lithium alloy for the anode in a sense that the lithium metal is precipitated on the anode. However, in the secondary battery, the lithium metal is precipitated on the anode material capable of inserting and extracting lithium, thereby it is considered that the secondary battery has the following advantages.

Firstly, in the conventional lithium secondary battery, it is difficult to uniformly precipitate the lithium metal, which causes degradation in cycle characteristics, however, the anode material capable of inserting and extracting lithium generally has a large surface area, so in the secondary battery, the lithium metal can be uniformly precipitated. Secondly, in the conventional lithium secondary battery, a change in volume according to precipitation and dissolution of the lithium metal is large, which also causes degradation in the cycle characteristics; however, in the secondary battery, the lithium metal is precipitated in gaps between particles of the anode material capable of inserting and extracting lithium, so a change in volume is small. Thirdly, in the conventional lithium secondary battery, the larger the amount of precipitation and dissolution of the lithium metal is, the bigger the above problem becomes; however, in the secondary battery, insertion and extraction of lithium by the anode material capable of inserting and extracting lithium contributes to a charge-discharge capacity, so in spite of a large battery capacity, the amount of precipitation and dissolution of the lithium metal is small. Fourthly, when the conventional lithium secondary battery is quickly charged, the lithium metal is more nonuniformly precipitated, so the cycle characteristics are further degraded. However, in the secondary battery, in an initial charge, lithium is inserted into the anode material capable of inserting and extracting lithium, so the secondary battery can be quickly charged.

In order to more effectively obtain these advantages, for example, it is preferable that at the maximum voltage before the open circuit voltage becomes an overcharge voltage, the maximum capacity of the lithium metal precipitated on the anode 22 is from 0.05 times to 3.0 times larger than the charge capacity of the anode material capable of inserting and extracting lithium. When the amount of precipitation of the lithium metal is too large, the same problem as the problem which occurs in the conventional lithium secondary battery arises, and when the amount is too small, the charge-discharge capacity cannot be sufficiently increased. Moreover, for example, the discharge capacity of the anode material capable of inserting and extracting lithium is preferably 150 mAh/g or over. The larger the ability to insert and extract lithium is, the smaller the amount of precipitation of the lithium metal relatively becomes. In addition, the charge capacity of the anode material is determined by the quantity of electricity when the battery with the anode made of the anode material as an anode active material and the lithium metal as a counter electrode is charged by a constant-current constant-voltage method until reaching 0 V. For example, the discharge capacity of the anode material is determined by the quantity of electricity when the battery is subsequently discharged in 10 hours or more by a constant-current method until reaching 2.5 V.

The separator 23 is made of, for example, a porous film of a synthetic resin such as polytetrafluoroethylene, polypropylene, polyethylene or the like, or a porous film of ceramic, and the separator 23 may have a structure in which two or more kinds of the porous films are laminated. Among them, a porous film made of polyolefin is preferably used, because by use of the porous film, a short circuit can be effectively prevented, and the safety of the battery can be improved by a shutdown effect. More specifically, polyethylene can obtain a shutdown effect within a range of from 100° C. to 160° C., and is superior in electrochemical stability, so polyethylene is preferably used as the material of the separator 23. Moreover, polypropylene is also preferably used, and any other resin having chemical stability can be used by copolymerizing or blending with polyethylene or polypropylene.

The porous film made of polyolefin is obtained through the following steps, for example. After a molten polyolefin composite is kneaded with a molten low-volatile solvent in liquid form to form a solution uniformly containing a high concentration of the polyolefin composite, the solution is extruded through a die, and is cooled to form a gel-form sheet, then the gel-form sheet is drawn to obtain the porous film.

As the low-volatile solvent, for example, a low-volatile aliphatic group such as nonane, decane, decalin, p-xylene, undecane, liquid paraffin or the like, or a cyclic hydrocarbon can be used. A composition ratio of the polyolefin composite and the low-volatile solvent is preferably 10 wt % to 80 wt % of the polyolefin composite, and more preferably 15 wt % to 70 wt % of the polyolefin composite, when the total ratio of the polyolefin composite and the low-volatile solvent is 100 wt %. When the composition ratio of the polyolefin composite is too small, during formation, swelling or neck-in becomes large at the exit of the die, so it is difficult to form the sheet. On the other hand, when the composition ratio of the polyolefin composite is too large, it is difficult to prepare a uniform solution.

When the solution containing a high concentration of the polyolefin composite is extruded through the die, in the case of a sheet die, a gap preferably has, for example, 0.1 mm to 5 mm. Moreover, it is preferable that an extrusion temperature is within a range of from 140° C. to 250° C., and an extrusion speed is within a range of from 2 cm/minute to 30 cm/minute.

The solution is cooled to at least a gelling temperature or less. As a cooling method, a method of directly making the solution contact with cooling air, cooling water, or any other cooling medium, a method of making the solution contact with a roll cooled by a cooling medium or the like can be used. Moreover, the solution containing a high concentration of the polyolefin composite which is extruded from the die may be pulled before or during cooling at a pulling ratio of from 1 to 10, preferably from 1 to 5. It is not preferable to pull the solution at a too large pulling ratio, because neck-in becomes large, and a rupture tends to occur during drawing.

It is preferable that, for example, the gel-form sheet is heated, and then is biaxially drawn through a tenter process, a roll process, a rolling process, or a combination thereof. At this time, either simultaneous drawing in all direction or sequential drawing may be used, but simultaneous secondary drawing is preferable. The drawing temperature is preferably equivalent to or lower than a temperature of 10° C. higher than the melting point of the polyolefin composite, and more preferably a crystal dispersion temperature or over and less than the melting point. A too high drawing temperature is not preferable, because effective molecular chain orientation by drawing cannot be achieved due to melting of the resin, and when the drawing temperature is too low, softening of the resin is insufficient, thereby a rupture of the gel-form sheet tends to occur during drawing, so the gel-form sheet cannot be drawn at a high enlargement ratio.

After drawing the gel-form sheet, the drawn film is preferably cleaned with a volatile solvent to remove the remaining low-volatile solvent. After cleaning, the drawn film is dried by heating or air blasting to volatilize the cleaning solvent. As the cleaning solvent, for example, an easily volatile material, that is, a hydrocarbon such as pentane, hexane, heptane or the like, a chlorinated hydrocarbon such as methylene chloride, carbon tetrachloride or the like, a fluorocarbon such as trifluoroethane or the like, ether such as diethyl ether, dioxane or the like is used. The cleaning solvent is selected depending upon the used low-volatile solvent, and one kind selected from the cleaning solvents or a mixture thereof is used. A method of immersing in the volatile solvent to extract, a method of sprinkling the volatile solvent, or a combination thereof can be used for cleaning. Cleaning is performed until the remaining low-volatile solvent in the drawn film becomes less than 1 part by mass relative to 100 parts by mass of the polyolefin composite.

The separator 23 is impregnated with an electrolyte solution which is a liquid electrolyte. The electrolyte solution includes a liquid solvent, for example, a nonaqueous solvent such as an organic solvent or the like, and a lithium salt which is an electrolyte salt dissolved in the nonaqueous solvent. The liquid nonaqueous solvent is made of, for example, a nonaqueous compound with an intrinsic viscosity of 10.0 mPa.s or less at 25° C. The nonaqueous solvent with an intrinsic viscosity of 10.0 mPa.s or less in a state that the electrolyte salt is dissolved therein may be used, and in the case where a plurality of kinds of nonaqueous compounds are mixed to form a solvent, the solvent may have an intrinsic viscosity of 10.0 mPa.s or less in a state that the compounds are mixed.

As such a nonaqueous solvent, various nonaqueous solvents conventionally used can be used. More specifically, cyclic carbonate such as propylene carbonate, ethylene carbonate or the like, chain ester such as diethyl carbonate, dimethyl carbonate, ethyl methyl carbonate or the like, ether such as γ-butyrolactone, sulfolane, 2-methyl tetrahydrofuran, dimethoxyethane or the like is cited. More specifically, in terms of oxidation stability, it is preferable to use the nonaqueous solvent mixed with carbonate.

As the lithium salt, for example, LiAsF₆, LiPF₆, LiBF₄, LiClO₄, LiB(C₆H₅)₄, LiCH₃SO₃, LiCF₃SO₃, LiN(CF₃SO₂)₂, LiN(C₂F₅SO₂)₂, LiN(C₄F₉SO₂)(CF₃SO₂), LiC(CF₃SO₂)₃, LiAlCl₄, LiSiF₆, LiCl or LiBr is cited, and one kind or a mixture including two or more kinds selected from them may be used.

Among them, LiPF₆ is preferable, because a higher conductivity can be obtained, and oxidation stability is superior, and LiBF₄ is preferable, because thermal stability and oxidation stability are superior. Moreover, LiCF₃SO₃ is preferable, because thermal stability is higher, and LiClO₄ is preferable, because a higher conductivity can be obtained. Further, LiN(CF₃SO₂)₂, LiN(C₂F₅SO₂)₂ and LiC(CF₃SO₂)₃ are preferable, because relatively high conductivity can be obtained, and thermal stability is high. Further, a mixture including at least two kinds selected from them is preferably used, because a combination of these effects can be obtained. More specifically, a mixture including at least one kind selected from the group consisting of lithium salts having a molecular structure shown in Chemical Formula 3 such as LiN(CF₃SO₂)₂, LiN(C₂F₅SO₂)₂, LiC(CF₃SO₂)₃ and so on and one or more kinds of other lithium salts except for the lithium salts having the molecular structure shown in Chemical Formula 3 is more preferably used, because higher conductivity can be obtained, and chemical stability of the electrolyte solution can be improved. As the other lithium salt, specifically LiPF₆ is preferable.

The content (concentration) of the lithium salt in the solvent is preferably within a range of 0.5 mol/kg to 3.0 mol/kg, because sufficient battery characteristics may not be obtained out of the range, because of a pronounced decline in ionic conductivity.

The electrolyte solution also includes at least one kind selected from the group consisting of a compound shown in Chemical Formula 4 and a compound shown in Chemical Formula 5 as an additive. Thereby, in the secondary battery, reduction and decomposition of the solvent can be inhibited in an insertion-extraction reaction of lithium, and a reaction between precipitated lithium metal and the solvent can be prevented in a precipitation-dissolution reaction of lithium. In other words, chemical stability of the electrolyte solution is improved, so a higher discharge capacity can be obtained, and cycle characteristics can be improved. In addition, the above compounds may function as a solvent, however, in the description, attention is given to the above function, so the compound is described as the additive. At least a part of the added compound may contribute to the above-described reaction, and the compound not contributing to the reaction may function as a solvent.

As the compound shown in Chemical Formula 4, for example, vinyl ethylene carbonate shown in Chemical Formula 6, vinyl ethylene trithiocarbonate shown in Chemical Formula 7, or 1,3-butadiene ethylene carbonate shown in Chemical Formula 8 is cited. As the compound shown in Chemical Formula 5, for example, divinyl ethylene carbonate shown in Chemical Formula 9 is cited. Among them, vinyl ethylene carbonate shown in Chemical Formula 6 or divinyl ethylene carbonate shown in Chemical Formula 9 is preferably included, because higher effects can be obtained.

In the case where two or more kinds of compounds are included, the total content of these compounds is preferably within a range of 0.005 wt % to 15 wt % relative to the total of the solvent and the electrolyte salt. When the content is less than 0.005 wt %, no sufficient effect can be obtained, and when the content is larger than 15 wt %, degradation in the battery during storage may occur.

Moreover, instead of the electrolyte solution, a gel electrolyte in which a high molecular weight compound holds an electrolyte solution may be used. Any gel electrolyte having an ionic conductivity of 1 mS/cm or over at room temperature may be used, and the composition of the gel electrolyte and the structure of the high molecular weight compound are not specifically limited. The electrolyte solution (that is, the liquid solvent, the electrolyte salt and the additive) is as described above. As the high molecular weight compound, for example, polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethylmethacrylate, polyacrylic acid, polymethacrylic acid, styrene-butadiene rubber, nitrile-butadiene rubber, polystyrene or polycarbonate is cited. Specifically, in terms of electrochemical stability, a high molecular weight compound having the structure of polyacrylonitrile, polyvinylidene fluoride, polyhexafluoropropylene or polyethylene oxide is preferably used. An amount of the high molecular weight compound added to the electrolyte solution varies depending upon compatibility between them, however, in general, an amount of the high molecular weight compound equivalent to 5 wt % to 50 wt % of the electrolyte solution is preferably added.

Moreover, the content of the compound shown in Chemical Formula 4 or 5 and the content of the lithium salt are the same as in the case of the electrolyte solution. Herein, the solvent widely means not only a liquid solvent but also a material capable of dissociating the electrolyte salt and having ionic conductivity. Therefore, when a high molecular weight compound with ionic conductivity is used as the high molecular weight compound, the high molecular weight compound is also considered to be a solvent.

The secondary battery can be manufactured through the following steps, for example.

At first, for example, a cathode material capable of inserting and extracting lithium, an electronic conductor, and a binder are mixed to prepare a cathode mixture, and the cathode mixture is dispersed in a solvent such as N-methyl-2-pyrrolidone or the like to produce cathode mixture slurry in paste form. After the cathode mixture slurry is applied to the cathode current collector 21a, and the solvent is dried, the cathode mixed layer 21b is formed through compression molding by a roller press or the like so as to form the cathode 21.

Next, for example, an anode material capable of inserting and extracting lithium and a binder are mixed to prepare an anode mixture, then the anode mixture is dispersed in a solvent such as N-methyl-2-pyrrolidone or the like to produce anode mixture slurry in paste form. After the anode mixture slurry is applied to the anode current collector 22a, and the solvent is dried, the anode mixed layer 22b is formed through compression molding by a roller press or the like so as to form the anode 22.

Then, the cathode lead 25 is attached to the cathode current collector 21a by welding or the like, and the anode lead 26 is attached to the anode current collector 22a by welding or the like. After that, for example, a laminate including the cathode 21 and anode 22 with the separator 23 in between is spirally wound, and an end portion of the cathode lead 25 is welded to the safety valve mechanism 15, and an end portion of the anode lead 26 is welded to the battery can 11. Then, the spirally wound laminate including the cathode 21 and the anode 22 sandwiched between a pair of insulating plates 12 and 13 is contained in the battery can 11. After the spirally wound laminate including the cathode 21 and the anode 22 is contained in the battery can 11, the electrolyte is injected into the battery can 11, and the separator 23 is impregnated with the electrolyte. After that, the battery cover 14, the safety valve mechanism 15 and the PTC device 16 are fixed in an opened end portion of the battery can 11 through caulking by the gasket 17. Thereby, the secondary battery shown in FIG. 1 is formed.

The secondary battery works as follows.

In the secondary battery, when charge is carried out, lithium ions are extracted from the cathode mixed layer 21b, and are inserted into the anode material capable of inserting and extracting lithium included in the anode mixed layer 22b through the electrolyte with which the separator 23 is impregnated. When the charge further continues, in a state where the open circuit voltage is lower than the overcharge voltage, the charge capacity exceeds the charge capacity of the anode material capable of inserting and extracting lithium, and then lithium metal begins to be precipitated on the surface of the anode material capable of inserting and extracting lithium. After that, until the charge is completed, precipitation of lithium metal on the anode 22 continues. Thereby, for example, when graphite is used as the anode material capable of inserting and extracting lithium, the color of the surface of the anode mixed layer 22b changes from black to gold, and then to silver.

Next, when discharge is carried out, at first, the lithium metal precipitated on the anode 22 is eluted as ions, and is inserted into the cathode mixed layer 21b through the electrolyte with which the separator 23 is impregnated. When the discharge further continues, lithium ions inserted into the anode material capable of inserting and extracting lithium in the anode mixed layer 22b are extracted, and are inserted into the cathode mixed layer 21b through the electrolyte. Therefore, in the secondary battery, the characteristics of the conventional lithium secondary battery and the lithium-ion secondary battery, that is, a higher energy density and superior charge-discharge cycle characteristics can be obtained.

More specifically in the embodiment, at least one selected from the compounds shown in Chemical Formulas 4 and 5 is included, so when lithium is inserted into the anode 22, in a radical active site, unsaturated alkyl groups R1, R2 and R3 in Chemical Formula 4 or 5 react, then these compounds are polymerized with each other by ring-opening polymerization, or are absorbed by the anode material capable of inserting and extracting lithium or polymerized with the anode material by ring-opening polymerization, so a film is formed on a surface of the anode 22. Thereby, reduction and decomposition of the solvent in the radical active site of the anode 22 can be inhibited. Moroever, the compound formed by the above reaction has a cyclic carbonate structure. For example, compared to a compound formed by ring-opening polymerization of vinylene carbonate, the degree of freedom of an oxo group which functions as a lithium ion conducting medium is high, so the film is considered to be a dense film with lithium ion conductivity. Therefore, it is considered that the precipitation of lithium metal is carried out under the film, and in a precipitation-dissolution reaction of lithium, a reaction between precipitated lithium metal and the solvent can be prevented by the film. Further, the film stably remains on the surface of the anode 22 even after the dissolution of lithium, so the above function is sustained in charge and discharge thereafter.

Thus, in the embodiment, at least one selected from the compounds shown in Chemical Formulas 4 and 5 is included, so when lithium is inserted into the anode 22, the unsaturated alkyl group R1, R2 and R3 in Chemical Formula 4 or 5 react in the radical active site so that the film can be formed on the surface of the anode 22, thereby reduction and decomposition of the solvent in the radical active site of the anode 22 can be inhibited. Moreover, in a precipitation-dissolution reaction of lithium, precipitation of lithium metal can be carried out under the film, so a reaction between the precipitated lithium metal and the solvent can be prevented. Therefore, the chemical stability of the electrolyte can be improved, and battery characteristics such as discharge capacity, charge-discharge cycle characteristics and so on can be improved.

More specifically, when the content of the above compound is within a range of 0.005 wt % to 15 wt % relative to the total of the solvent and the electrolyte salt, higher effects can be obtained.

Next, specific examples of the invention will be described in more detail below referring to FIGS. 1 and 2.

### EXAMPLES 1 THROUGH 4

Batteries in which the area density ratio of the cathode 21 and the anode 22 was adjusted, and the capacity of the anode 22 included a capacity component by insertion and extraction of lithium and a capacity component by precipitation and dissolution of the lithium, and was represented by the sum of them were formed.

At first, lithium carbonate (Li₂CO₃) and cobalt carbonate (CoCO₃) were mixed at a ratio (molar ratio) of Li₂CO₃:CoCO₃=0.5:1, and the mixture was fired in air at 900° C. for 5 hours to obtain lithium cobalt complex oxide (LiCoO₂) as the cathode material. Next, 91 parts by weight of lithium cobalt complex oxide, 6 parts by weight of graphite as an electronic conductor and 3 parts by weight of polyvinylidene fluoride as a binder were mixed to prepare a cathode mixture. Then, the cathode mixture was dispersed in N-methyl-2-pyrrolidone as a solvent to form cathode mixture slurry. After the cathode mixture slurry was uniformly applied to both sides of the cathode current collector 21a made of strip-shaped aluminum foil with a thickness of 20 μm, and was dried. Then, the cathode mixed layer 21b was formed through compression molding by a roller press so as to form the cathode 21. After that, the cathode lead 25 made of aluminum was attached to an end of the cathode current collector 21a.

Moreover, artificial graphite powder was prepared as an anode material, and 90 parts by weight of the artificial graphite powder and 10 parts by weight of polyvinylidene fluoride as a binder were mixed to prepare an anode mixture. Next, the anode mixture was dispersed in N-methyl-2-pyrrolidone as a solvent to form anode mixture slurry. After the anode mixture slurry was uniformly applied to both sides of the anode current collector 22a made of strip-shaped copper foil with a thickness of 10 μm, and was dried. Then, the anode mixed layer 22b was formed through compression molding by a roller press so as to form the anode 22. Next, the anode lead 26 made of nickel was attached to an end of the anode current collector 22a.

After the cathode 21 and the anode 22 were formed, the separator 23 made of a porous polypropylene film with a thickness of 25 μm was prepared. Then, a laminate including the anode 22, the separator 23, the cathode 21 and the separator 23 in this order was spirally wound several times to form the spirally wound electrode body 20.

After the spirally wound electrode body 20 was formed, the spirally wound electrode body 20 was sandwiched between a pair of insulating plates 12 and 13, and the anode lead 26 was welded to the battery can 11, and the cathode lead 25 was welded to the safety valve mechanism 15. Then, the spirally wound electrode body 20 was contained in the battery can 11 made of nickel-plated iron. After that, the electrolyte solution was injected into the battery can 11 by a decompression method. As the electrolyte solution, a mixed solvent of 50 vol % of ethylene carbonate and 50 vol % of diethyl carbonate with LiPF₆ as the electrolyte salt dissolved therein at a ratio of 1 mol/dm³ to which vinyl ethylene carbonate shown in Chemical Formula 6 added thereto was used. At that time, the content of vinyl ethylene carbonate relative to the total of the solvent and the electrolyte salt varied in Examples 1 through 4 as shown in Table 1.

After the electrolyte solution was injected into the battery can 11, the battery cover 14 was caulked into the battery can 11 by the gasket 17 of which a surface was coated with asphalt so as to obtain the cylindrical secondary batteries with a diameter of 14 mm and a height of 65 mm of Examples 1 through 4 were formed.

As Comparative Example 1 relative to Examples, a secondary battery was formed as in the case of Examples, except that vinyl ethylene carbonate was not added to the electrolyte solution. Moreover, as Comparative Examples 2 and 3 relative to Examples, lithium-ion secondary batteries were formed as in the case of Examples, except that the area density ratio of the cathode and the anode was adjusted, and the capacity of the anode was represented by insertion and extraction of lithium. At that time, in Comparative Example 2, a vinyl ethylene carbonate content of 2 wt % relative to the solvent was added to the electrolyte solution, and in Comparative Example 3, vinyl ethylene carbonate was not added to the electrolyte solution.

A charge-discharge test was carried out on the secondary batteries of Examples 1 through 4 and Comparative Examples 1 throuth 3 to determine a discharge capacity in the first cycle, that is, an initial discharge capacity, and a discharge capacity in the 100th cycle. At that time, charge was carried out at a constant current of 600 mA until a battery voltage reached 4.2 V, then the charge was continued at a constant voltage of 4.2 V until a current reached 1 mA. Discharge was carried out at a constant current of 400 mA until the battery voltage reached 3.0 V. When charge and discharge were carried out under the conditions, the batteries were in a full charge condition and a full discharge condition. The obtained results are shown in Table 1. In Table 1, the initial discharge capacity of each of Examples 1 through 4 was a relative value when the initial discharge capacity of Comparative Example 1 was 100, and the discharge capacity of each of Examples 1 through 4 in the 100th cycle was a relative value when the discharge capacity of Comparative Example 1 in the 100th cycle was 100. Moreover, the initial discharge capacity of Comparative Example 2 was a relative value when the initial discharge capacity of Comparative Example 3 was 100, and the discharge capacity of Comparative Example 2 in the 100th cycle was a relative value when the discharge capacity of Comparative Example 3 in the 100th cycle was 100.

Moreover, after the first cycle of charge and discharge was carried out on the secondary batteries of Examples 1 through 4 and Comparative Examples 1 through 3 under the above-described conditions, the batteries were fully charged again, then the fully charged batteries were disassembled to check whether the lithium metal was precipitated on the anode mixed layer 22b by visual inspections and ⁷Li nuclear magnetic resonance spectroscopy. Further, the second cycle of charge and discharge was carried out under the above-described conditions to fully discharge the batteries, then the batteries were disassembled to check whether the lithium metal was precipitated on the anode mixed layer 22b in a like manner.

As a result, in the secondary batteries of Examples 1 through 4 and Comparative Example 1, in a full charge condition, precipitation of lithium metal on the anode mixed layer 22b was observed, and in a full discharge condition, no precipitation of lithium metal was observed. In other words, it was confirmed that the capacity of the anode 22 included a capacity component by precipitation and dissolution of lithium metal and a capacity component by insertion and extraction of lithium metal, and was represented by the sum of them. In Table 1, Y denotes the presence of precipitated lithium metal.

On the other hand, in the secondary batteries of Comparative Examples 2 and 3, in a full charge condition and a full discharge condition, no precipitation of lithium metal was observed, and only the presence of lithium ions was observed. Moreover, a peak attributed to the observed lithium ions was extremely small. In other words, it was confirmed that the capacity of the anode was represented by insertion and extraction of lithium. In Table 1, N denotes the absence of precipitated lithium metal.

It was obvious from Table 1 that the batteries of Examples 1 through 4 in which vinyl ethylene carbonate was added to the electrolyte solution could obtain the initial discharge capacity and the discharge capacity in the 100th cycle equivalent to or higher than the battery of Comparative Example 1 in which no vinyl ethylene carbonate was added to the electrolyte solution, and specifically the discharge capacity in the 100th cycle could be improved more than that in Comparative Example 1. On the other hand, in the lithium-ion secondary batteries of Comparative Examples 2 and 3, the lithium-ion secondary battery of Comparative Example 2 in which vinyl ethylene carbonate was added to the electrolyte solution could obtain a slightly higher initial discharge capacity and a slightly higher discharge capacity in the 100th cycle than the lithium-ion secondary battery of Comparative Example 3 in which no vinyl ethylene carbonate was added to the electrolyte solution, however, compared to Example 2 in which the same content of vinyl ethylene carbonate was added to the electrolyte solution, vinyl ethylene carbonate in Comparative Example 2 produced a little effect. In other words, it was found out that the secondary battery in which the capacity of the anode 22 included the capacity component by insertion and extraction of light metal and the capacity component by precipitation and dissolution of light metal, and was represented by the sum of them, when vinyl ethylene carbonate was included in the electrolyte solution, the discharge capacity and the charge-discharge cycle characteristics could be improved.

Moreover, it was found out from the results of Examples 1 through 4 that in accordance with an increase in the vinyl ethylene carbonate content, there was a tendency of the initial discharge capacity and the discharge capacity in the 100th cycle to increase, and decrease after reaching the maximum value. In other words, it was found out that when the vinyl ethylene carbonate content in the electrolyte solution was within a range of 0.005 wt % to 15 wt % relative to the total of the solvent and the electrolyte salt, higher effects could be obtained.

### EXAMPLES 5 THROUGH 7

Secondary batteries were formed as in the case of Example 2, except that instead of vinyl ethylene carbonate, vinyl ethylene trithiocarbonate shown in Chemical Formula 7, 1,3-butadiene ethylene carbonate shown in Chemical Formula 8, or divinyl ethylene carbonate shown in Chemical Formula 9 was added to the electrolyte solution. The charge-discharge test was carried out on Examples 5 through 7 as in the case of Example 2 to determine the initial discharge capacity and the discharge capacity in the 100th cycle, and to check whether the lithium metal was precipitated in a full charge condition and in a full discharge condition. The results are shown in Table 2 together with the results of Example 2 and Comparative Example 1. In Table 2, the initial discharge capacity was a relative value when the initial capacity of Comparative Example 1 was 100, and the discharge capacity in the 100th cycle was a relative value when the discharge capacity of Comparative Example 1 in the 100th cycle was 100.

It was obvious from Table 2 that as in the case of Example 2, the secondary batteries of Examples 5 through 7 could obtain the initial discharge capacity and the discharge capacity in the 100th cycle higher than those in Comparative Example 1. In other words, it was found out that when the compound shown in Chemical Formula 4 or 5 was included in the electrolyte solution, the discharge capacity and the charge-discharge cycle characteristics could be improved.

In the above examples, the description is given referring to specific examples of the compound shown in Chemical Formula 4 or Chemical Formula 5; however, it is considered that the above-described effects result from the molecular structure shown in Chemical Formula 4 or Chemical Formula 5. Therefore, the same effects can be obtained by using any other compound shown in Chemical Formula 4 or Chemical Formula 5. Moreover, in the above examples, the case where the electrolyte solution is used is described, although the same effects can be obtained by using a gel electrolyte.

The present invention is described referring to the embodiment and the examples, but the invention is not limited to the above embodiment and the examples, and is variously modified. For example, in the embodiment and the examples, the case where lithium is used as light metal is described; however, the invention can be applied to the case where any other alkali metal such as sodium (Na), potassium (K) or the like, alkaline-earth metal such as magnesium, calcium (Ca) or the like, any other light metal such as aluminum or the like, lithium, or an alloy thereof is used, thereby the same effects can be obtained. In this case, the anode material capable of inserting and extracting light metal, the cathode material, the nonaqueous solvent, the electrolyte salt or the like is selected depending upon the light metal. However, lithium or an alloy including lithium is preferably used as the light metal, because voltage compatibility with lithium-ion secondary batteries which are practically used at present is high. Further, when the alloy including lithium is used as the light metal, a material capable of forming an alloy with lithium may be present in the electrolyte or the anode so as to form an alloy during precipitation.

Moreover, in the above embodiments and the examples, the case where the electrolyte solution or the gel electrolyte which is a kind of solid electrolyte is used is described, but any other electrolyte may be used. As the electrode, for example, an organic solid electrolyte in which an electrolyte salt is dispersed in a high molecular weight compound having ionic conductivity, an inorganic solid electrolyte made of ion-conductive ceramic, ion-conductive glass, ionic crystal or the like, a mixture of the inorganic solid electrolyte and an electrolyte solution, a mixture of the inorganic solid electrolyte and the gel electrolyte, or a mixture of the inorganic solid electrolyte and the organic solid electrolyte is cited.

Further, in the above embodiment and the examples, the cylindrical type secondary battery with a spirally wound structure is described; however, the invention is applicable to an elliptic type or a polygonal type secondary battery with a spirally wound structure, or a secondary battery with a structure in which the cathode and anode are folded or laminated in a like manner. In addition, the invention is applicable to a secondary battery with a coin shape, a button shape, a prismatic shape, a large size or the like. Further, the invention is applicable to not only the secondary batteries but also primary batteries.

As described above, in the battery according to the invention, the electrolyte includes at least one kind selected from the compounds shown in Chemical Formula 1 and Chemical Formula 2, so when light metal is inserted into the anode, the unsaturated alkyl group R1, R2 and R3 react in the radical active site, so a film can be formed on the surface of the anode. Thereby, reduction and decomposition of the solvent in the radical active site of the anode can be inhibited. Moreover, in the precipitation-dissolution reaction of light metal, the precipitation of the light metal can be carried out under the film, so a reaction between the precipitated light metal and the solvent can be prevented. Therefore, the chemical stability of the electrolyte can be improved, and the battery characteristics such as the discharge capacity, the charge-discharge cycle characteristics and so on can be improved.

More specifically, in the battery according to an aspect of the invention, the content of the compound shown in Chemical Formula 1 or Chemical Formula 2 is within a range of 0.005 wt % to 15 wt % relative to the total of the solvent and the electrolyte salt, so higher effects can be obtained.

Obviously many modifications and variations of the present invention are possible in the light of the above teachings. It is therefore to be understood that within the scope of the appended claims the invention may be practiced otherwise than as specifically described. 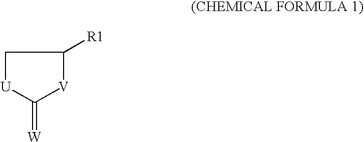
(where each of U, V and W represents one kind of Group 6B element, and R 1 represents an unsaturated alkyl group.) 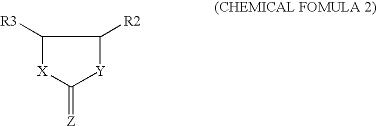
(where each of X, Y and Z represents one kind of Group 6B element, and each of R 2 and R 3 represents an unsaturated alkyl group.)
(CaFbSOc)d (CHEMICAL FORMULA 3)
(where each of a, b, c and d represents any number except for 0.) 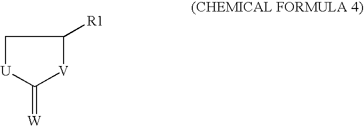
(where each of U, V and W represents one kind of Group 6B element, and R 1 represents an unsaturated alkyl group.)

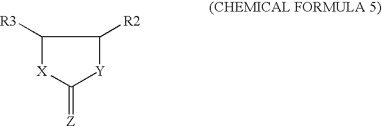

(where each of X, Y and Z represents one kind of Group 6B element, and each of R 2 and R 3 represents an unsaturated alkyl group.)

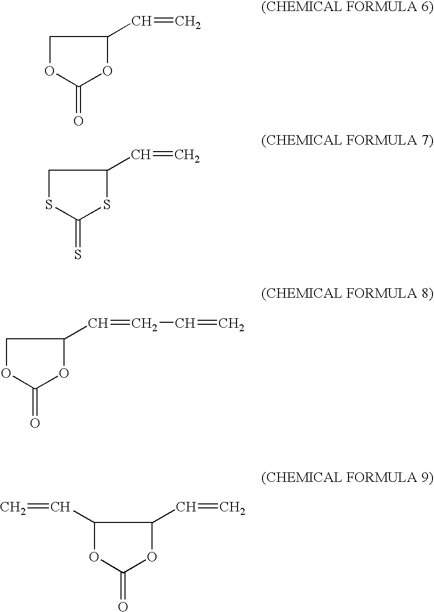

TABLE 1

| | | INITIAL | 100TH | |
|---|---|---|---|---|
| | VINYL | DIS- | CYCLE | PRE- |
| | ETHYLENE | CHARGE | DISCHARGE | CIPI- |
| | CARBONATE | CAPACITY | CAPACITY | TATION |
| | (WT %) | (mAh) | (mAh) | OF Li |
| EXAM- | 0.005 | 101 | 101 | Y |
| PLE 1 | | | | |
| EXAM- | 2 | 111 | 115 | Y |
| PLE 2 | | | | |
| EXAM- | 10 | 105 | 105 | Y |
| PLE 3 | | | | |
| EXAM- | 15 | 99 | 102 | Y |
| PLE 4 | | | | |
| COMPARA- | 0 | 100 | 100 | Y |
| TIVE EX- | | | | |
| AMPLE 1 | | | | |
| COMPARA- | 2 | 102 | 103 | N |
| TIVE EX- | | | | |
| AMPLE 2 | | | | |
| COMPARA- | 0 | 100 | 100 | N |
| TIVE EX- | | | | |
| AMPLE 3 | | | | |

TABLE 2

| | | INITIAL | 100TH | |
|---|---|---|---|---|
| | | DIS- | CYCLE | |
| | | CHARGE | DISCHARGE | PRECIPI- |
| | KIND OF | CAPACITY | CAPACITY | TATION |
| | ADDITIVE | (mAh) | (mAh) | OF Li |
| EXAM- | VINYL | 111 | 115 | Y |
| PLE 2 | ETHYLENE | | | |
| | CARBONATE | | | |
| EXAM- | VINYL | 106 | 110 | Y |
| PLE 5 | ETHYLENE | | | |
| | TRITHIO- | | | |
| | CARBONATE | | | |
| EXAM- | 1,3-BUTADIENE | 104 | 108 | Y |
| PLE 6 | ETHYLENE | | | |
| | CARBONATE | | | |
| EXAM- | DIVINYL | 108 | 113 | Y |
| PLE 7 | ETHYLENE | | | |
| | CARBONATE | | | |
| COM- | — | 100 | 100 | Y |
| PARA- | | | | |
| TIVE | | | | |
| EXAM- | | | | |
| PLE 1 | | | | |

1. A battery, comprising:
a cathode;
an anode; and
an electrolyte,
wherein the capacity of the anode includes a capacity component by insertion and extraction of light metal and a capacity component by precipitation and dissolution of the light metal, and is represented by the sum of them, and
the electrolyte include at least one kind selected from the group consisting of a compound shown in Chemical Formula 10 and a compound shown in Chemical Formula 11.

2. A battery according to claim 1, wherein
the electrolyte further includes a solvent and an electrolyte salt, and the total content of the compound shown in Chemical Formula 10 and the compound shown in Chemical Formula 11 is within a range of 0.005 wt % to 15 wt % relative to the total of the solvent and the electrolyte salt.

3. A battery according to claim 1, wherein
the electrolyte includes vinyl ethylene carbonate.

4. A battery according to claim 1, wherein
the electrolyte includes divinyl ethylene carbonate.

5. A battery according to claim 1, wherein
the electrolyte includes a mixture of at least one kind of lithium salt selected from the group consisting of LiN(CF₃SO₂)₂, LiN(C₂F₅SO₂)₂ and LiC(CF₃SO₂)₃ and one or more kinds of other lithium salts.

6. A battery according to claim 1, wherein
the anode includes an anode material capable of inserting and extracting light metal.

7. A battery according to claim 6, wherein
the anode includes a carbon material.

8. A battery according to claim 7, wherein
the anode includes at least one kind selected from the group consisting of graphite, graphitizing carbon and non-graphitizable carbon.

9. A battery according to claim 8, wherein
the anode includes graphite.

10. A battery according to claim 6, wherein
the anode includes at least one kind selected from the group consisting of single substances, alloys and compounds of metal elements capable of forming an alloy with the light metal and metalloid elements capable of forming an alloy with the light metal.

11. A battery according to claim 10, wherein
the anode includes at least one kind selected from the group consisting of single substances, alloys and compounds of tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y) and hafnium (Hf).

12. A battery according to claim 1, wherein
the electrolyte includes a high molecular weight compound. 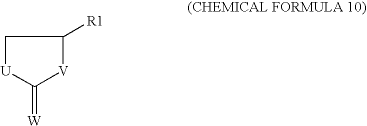
(where each of U, V and W represents one kind of Group 6B element, and R 1 represents an unsaturated alkyl group.) 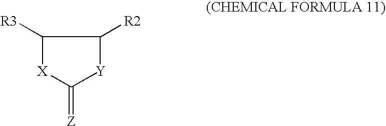
(where each of X, Y and Z represents one kind of Group 6B element, and each of R 2 and R 3 represents an unsaturated alkyl group.)
